(19) United States
(12) Patent Application Publication
(10) Pub. No.: US 2023/0175197 A1
(43) Pub. Date: Jun. 8, 2023

(54) AM/AV METAL LOADING VIA WET TREATMENT

(71) Applicant: Ascend Performance Materials Operations LLC, Houston, TX (US)

(72) Inventors: Victor G. Kholodkov, Houston, TX (US); Wai-shing Yung, Houston, TX (US)

(73) Assignee: Ascend Performance Materials Operations LLC, Houston, TX (US)

(21) Appl. No.: 18/061,143

(22) Filed: Dec. 2, 2022

Related U.S. Application Data
(60) Provisional application No. 63/285,632, filed on Dec. 3, 2021.

(51) Int. Cl. D06M 11/83; D06M 23/10

(52) U.S. Cl. CPC D06M 11/83; D06M 23/10; D06M 2101/16

(57) ABSTRACT

A wet treatment process, the process comprising: adding an article comprising a polymer and an initial zinc content to a wash solution comprising solute and a wash solution zinc content; maintaining the article in the wash solution for a wash time greater than 10 seconds to yield a washed article comprising a washed zinc content; wherein the washed zinc content is greater than the initial zinc content; and wherein the washed article demonstrates a Klebsiella pneumonia log reduction greater than 0.90, as determined via ISO20743:2013 and/or an Escherichia coli log reduction greater than 1.5, as determined via ASTM E3160 (2018).

### CROSS-REFERENCE

This application is related to and claims priority to U.S. Provisional Patent Application No. 63/285,632 filed Dec. 3, 2021, which is incorporated herein by reference.

### FIELD

The present disclosure relates to processes for improving antimicrobial/antiviral properties in an article, e.g., an article, particularly to a wet treatment process that uses a zinc-containing wash solution comprising zinc.

### BACKGROUND

Some antimicrobial/antiviral (AM/AV) articles, e.g., fabrics, have been developed. These articles are prepared from fibers or yarns made from AM/AV compositions that comprise a polymer and an AM/AV compound, e.g., an AM/AV metal such as zinc or copper. One example of such articles is disclosed in U.S. Pat. No. 11,185,071 to Yung and Osborn. In these fibers and yarns, the antimicrobial agents are in the matrix polymer, as opposed to being coated onto the non AM/AV yarns, which provides for both efficacy and AM/AV retention (when washed) benefits.

U.S. Pat. No. 11,185,071 discloses polymer compositions, fibers, and yarns having near-permanent antimicrobial activity along with a method of producing same. The antimicrobial polymer composition comprises from 50 wt % to 99.9 wt % of a polymer, from 5 wppm to 1000 wppm of zinc, and from 0.005 wt % to 1 wt % of phosphorus. Fibers formed from the polymer composition demonstrate a zinc retention rate of greater than 20% when tested in a dye bath test.

While these articles have the AM/AV metals in the polymer matrix, the laws of thermodynamics suggest that there may be some (slight) mass transfer of zinc from the article to wash water during wash a wash cycle, due to the zinc concentration gradient. This loss of zinc may detrimentally affect overall AM/AV efficacy. As a result, the AM/AV bioefficacy of the article may deteriorate, albeit slightly, after multiple wash cycles.

Even in view of the references, the need exists for processes treating articles so as to maintain or even increase AM/AV metal content thereof during one or more wash cycles.

### BRIEF DESCRIPTION OF THE DRAWINGS

The present disclosure is described in detail below with reference to the appended drawings, wherein like numerals designate similar parts.

FIG. 1 is a graph showing increase in zinc content in relation to wash cycles.

FIG. 2 is a graph showing zinc content and AM/AV performance in relation to wash cycles.

FIG. 3 is a graph showing improvements in AM/AV performance in relation to added zinc content.

### SUMMARY

In one embodiment, the disclosure relates to a wet treatment process, the process comprising adding an article comprising a polymer (PA6, PA66, PA10, PA12, PA6T, or PA6I, or copolymers or terpolymers thereof) and an initial AM/AV metal content, e.g., an initial zinc content, to a wash solution comprising a solute, e.g., water, (optionally municipal water comprising zinc or water and an added zinc compound) and a wash solution AM/AV metal content, e.g., a wash solution zinc content, e.g., from 1 ppb to 100 ppm zinc and optionally having a pH greater than 3.5; maintaining the article in the wash solution for a wash time greater than 10 seconds to yield a washed article comprising a washed AM/AV metal content, e.g., a washed zinc content, optionally greater than 600 ppm. The washed AM/AV metal content, e.g., washed zinc content, is greater than, e.g., at least 10% greater than, the initial AM/AV metal content, e.g., the initial zinc content, and/or the difference between the washed AM/AV metal content, e.g., the washed zinc content, and the initial AM/AV metal content, e.g., the initial zinc content, is greater than the wash solution AM/AV metal content, e.g., the wash solution zinc content, and/or the washed AM/AV metal content, e.g., the washed zinc content, is greater than the wash solution AM/AV metal content, e.g., the wash solution zinc content. The washed article may demonstrate a Klebsiella pneumonia log reduction greater than 0.90, e.g., greater than 3 as determined via ISO20743:2013 and/or an Escherichia coli log reduction greater than 1.5, e.g., greater than 3, as determined via ASTM E3160 (2018) and/or a log reduction increase of at least 1.0 over the log reduction of the article and/or may comprise greater than 600 ppm zinc and/or have an RV greater than 2 and/or the antiviral/antimicrobial efficacy of the washed article may increase after the maintaining step and/or AM/AV metal retention, e.g., zinc retention, may be over 100%, e.g., AM/AV metal content, e.g., zinc content, growth. A wash cycle may be an addition step followed by a maintenance step and wherein the process comprises multiple wash cycles and the washed AM/AV metal content, e.g., washed zinc content, may be at least 50% greater than the initial AM/AV metal content, e.g., initial zinc content, after 40 wash cycles.

The disclosure also relates to a detergent pod comprising soap and AM/AV metal compound, e.g., zinc compound. The disclosure also relates to a process for washing an article comprising a polymer to add AM/AV metal content, e.g., zinc content, the process comprising adding an article comprising a polymer and an initial AM/AV metal content, e.g., an initial zinc content, to a wash solution comprising water and the detergent pod; an maintaining the article in the wash solution for a wash time greater than 10 seconds to yield a washed article comprising a washed AM/AV metal content, e.g., a washed zinc content; wherein the washed AM/AV metal content, e.g., the washed zinc content, is greater than the initial AM/AV metal content, e.g., the initial zinc content; and wherein the washed article may demonstrate a Klebsiella pneumonia log reduction greater than 0.90, as determined via ISO20743:2013 and/or an Escherichia coli log reduction greater than 1.5, as determined via ASTM E3160 (2018). The wash solution may comprise water and a wash solution AM/AV metal content, e.g., wash solution zinc content. The washed AM/AV metal content, e.g., washed zinc content, may be at least 10% greater than the initial AM/AV metal content, e.g., initial zinc content. The washed AM/AV metal content, e.g., washed zinc content, may be greater than the wash solution AM/AV metal content, e.g., the wash solution zinc content.

### DETAILED DESCRIPTION

As noted above, conventional antimicrobial/antiviral (AM/AV) articles, e.g., those, made from fibers or yarns made from AM/AV compositions that comprise a polymer and an AM/AV compound, e.g., an AM/AV metal such as zinc or copper, have been developed. As robust and effective as these articles may be, the laws of thermodynamics suggest the possibility of some (slight) mass transfer of zinc from the article to wash water during a wash cycle, which may result in a drop in the AM/AV bioefficacy of the article after multiple wash cycles.

It has now been discovered that, for some articles, e.g., articles, made from particular polymer compositions, when washed in a specific wash solution (with a specific concentration of AM/AV metal, e.g., zinc), the AM/AV metal content in the article will advantageously maintain at its initial level or even increase.

Without being bound by theory, it is postulated that particular partition coefficients will lead to the migration or absorption of AM/AV metal into the article, e.g., from a lower AM/AV metal concentration environment to a higher AM/AV metal concentration environment. Certain AM/AV metals, e.g., zinc and certain polymers, e.g., polyamides such as PA6, PA66, PA10, PA12, PA6T, or PA6I, or copolymers or terpolymers thereof, have a high affinity to the AM/AV metals. As a result, the particular AM/AV metals (present in the wash solution) prefer to migrate into the polymer, even at very low concentration levels. In theory, it would be expected that the AM/AV metal would migrate out of the fibers because of the higher concentration in the fibers. However, surprisingly and unexpectedly, the opposite happens—the AM/AV metal migrates from the wash solution to the fibers/yarns, e.g., from a low concentration to a higher concentration.

In addition, the inventors have discovered that wash solution pH has an unexpected effect on migration or absorption of AM/AV metal into the article, e.g., the fabric. It is posited that the presence of hydronium (H₃O⁺) ions changes the relative attractive force between or affinity to the metal ions and the fabric material versus those in solution.

In contrast, conventional treatment or washing processes, which employ conventional wash solutions and/or different articles, and/or different partition coefficients, tend to effectuate the leaching of AM/AV metal out of the article, which leads to the deleterious AM/AV effects mentioned above.

### Wet Treatment Process

This disclosure relates to a wet treatment process for treating (washing) an article, e.g., a fabric. In some cases, the article is a fabric, but the disclosure is not limited thereto—a wide variety of articles are contemplated. The process comprises the step of adding an article to a wash solution comprising water and AM/AV metal, e.g., zinc. The wash solution comprises the AM/AV metal at a particular wash solution content, e.g., zinc content, and optionally has a specific pH, discussed in more detail herein. In some cases, the article comprises a specific polymer or mixture of polymers along with AM/AV metal, e.g., zinc, present at an initial content. In other cases, the article does not comprise an initial AM/AV metal (but AM/AV is added via the treatment). The process further comprises the step of maintaining the article in the wash solution for a (certain predetermined) wash time, e.g., greater than 10 seconds, to yield a washed article. The washed article comprises the polymer and AM/AV metal, e.g., zinc, and the metal is present at a washed AM/AV metal content, e.g., zinc content. References to the AM/AV metal include zinc as one example thereof, but also may include other metals that have AM/AV properties. Beneficially, the washed article has improved AM/AV properties versus the AM/AV properties of the initial article. Stated another way, the AM/AV efficacy of the washed article increases after the maintaining step. For example, the washed article demonstrates a Klebsiella pneumonia log reduction greater than 0.90, as determined via ISO20743:2013 and/or an Escherichia coli log reduction greater than 1.5, as determined via ASTM E3160 (2018). Other AM/AV performance features are also demonstrated, as discussed herein.

As a result of the particular AM/AV metals (and concentrations thereof), polymers, and associated partition coefficients (and optionally pH levels), the washed AM/AV metal content, e.g., zinc content is advantageously greater than (or equal to) the initial AM/AV metal content, e.g., zinc content.

In some cases, the washed AM/AV metal content is at least 10% greater than the initial AM/AV metal content, e.g., at least 20% greater, at least 30% greater, at least 40% greater, at least 50% greater, at least 60% greater, at least 70% greater, at least 80% greater, at least 90% greater, or at least 100% greater.

In cases where high zinc content (in the article) is desired, the combination of the initial zinc content and added zinc (via treatment) provides for zinc content that was not previously achievable.

In some embodiments, the treatment of an article without an initial zinc content advantageously provides for the addition of zinc content, which in turn, provides for AM/AV performance.

In some embodiments, the washed AM/AV metal content is greater than 400 ppm, e.g., greater than 500 ppm, greater than 550 ppm, greater than 600 ppm, greater than 650 ppm, greater than 700 ppm, greater than 800 ppm, greater than 900 ppm, or greater than 1000 ppm. In terms of ranges, the washed AM/AV metal content may range from 400 ppm to 25000 ppm, e.g., from 400 ppm to 25000 ppm, from 550 ppm to 20000 ppm, from 600 ppm to 15000 ppm, from 700 ppm to 15000 ppm, or from 750 ppm to 10000 ppm.

In some cases, the washed article comprises zinc at the washed zinc content level and has a relative viscosity (RV) greater than 2, e.g., greater than 5, greater than 10, greater than 15, greater than 20, greater than 25, greater than 30, greater than 35, greater than 40, greater than 50, greater than 60, or greater than 75. In terms of ranges, the washed article has a relative viscosity ranging from 2 to 150, e.g., from 5 to 100, from 10 to 75 or from 20 to 70. Other RV ranges and limits are disclosed herein. These ranges and limits are also applicable to the washed article (or to the initial article).

Surprisingly, the final zinc concentration in the washed article may exceed the initial concentration of zinc in the wash solution. Said another way, the difference between the washed zinc content and the initial zinc content is greater than the wash solution zinc content (the concentration of zinc in the wash solution). This result is unexpected because it would be expected that the treatment would achieve, at most, an increase that is as high as the maximum wash solution zinc content. Stated another way, the maximum increase would be expected to be only as high as the wash solution zinc content. It is possible that the AM/AV metal, e.g., zinc, has a particularly high partition coefficient for the polymer, e.g., PA66, and prefers to migrate into PA66 even when at a very low concentration in the wash solution.

In some embodiments, the washed AM/AV metal content is greater than the wash solution AM/AV metal content, e.g., at least 10% greater, at least 20% greater, at least 30% greater, at least 40% greater, at least 50% greater, at least 60% greater, at least 70% greater, at least 80% greater, at least 90% greater, or at least 100% greater. In some cases, AM/AV metal of the wash fabric may show an increase is over 100%, which signifies that the fabric has a very strong affinity for AM/AV metal.

In some cases, e.g., in real world use, multiple wash cycles are performed, e.g., in domestic and/or industrial (health care) settings. The wash cycle is an addition step (of AM/AV metal) followed by the respective maintenance step (addition of AM/AV metal (via a detergent pod into the wash solution) then soaking of the article in the wash solution). In some cases, the washed zinc content is at least 50% greater than the initial zinc content after 10 wash cycles, e.g., after 20 wash cycles, after 30 wash cycles, after 40 wash cycles, or after 50 wash cycles.

In addition, the disclosure relates to a process for washing an article comprising a polymer to add zinc content. The process comprises the step of adding the article to the wash solution and maintaining the article in the wash solution for a wash time greater than 10 seconds to yield a washed article comprising a washed zinc content. The washed article has the composition and performance mentioned above.

The article may be maintained in the wash solution for a time sufficient to effectuate the zinc content growth. In some cases, the article is maintained in the wash solution for a time period greater than 10 seconds, e.g., greater than 60 seconds, greater than 5 minutes, greater than 10 minutes, greater than 20 minutes, greater than 30 minutes, greater than 45 minutes, greater than 1 hour, or greater than 2 hours. In some cases, the wash time may range from 10 seconds to 10 hours, e.g., from 1 minute to 5 hours, from 10 minutes to 3 hours, from 20 minutes to 2 hours, or from 20 minutes to 1 hour.

### Wash Solution

The wash solution comprises a solution, e.g., solute, for example, water, and AM/AV compound. The wash solution may also comprise other optional components, for example a detergent or detergent package or a pH adjuster, e.g., an alkaline additive. As used herein, references to AM/AV compound are meant to include zinc, and references to zinc may be imputed to AM/AV compounds generally. Generally, suitable solvents include those that are capable of forming zinc ions. Exemplary solutes include water and alcohols.

The zinc content of the wash solution may range from 1 ppb to 25000 ppm zinc, e.g., from 10 ppb to 2500 ppm; from 10 ppb to 2000 ppm; from 100 ppb to 2500 ppm; from 10 ppm to 2000 ppm; from 10 ppm to 1000 ppm; from 10 ppm to 500 ppm; from 20 ppm to 250 ppm; from 100 ppm to 2500 ppm; from 150 ppm to 2000 ppm; from 200 ppm to 22000 ppm; from 1500 ppm to 22000 ppm; from 1800 ppm to 22000 ppm; or from 2000 ppm to 20000 ppm. In terms of lower limits, the wash solution may comprise greater than 1 ppb zinc, e.g., greater than 10 ppb, greater than 100 ppb, greater than 1 ppm, greater than 10 ppm, greater than 20 ppm, greater than 100 ppm, greater than 150 ppm, greater than 200 ppm, greater than 500 ppm, greater than 750 ppm, greater than 1000 ppm, greater than 1500 ppm, greater than 1800 ppm, greater than 2000 ppm, greater than 5000 ppm, greater than 10000 ppm, or greater than 15000 ppm. In terms of upper limits, the wash solution may comprise less than 25000 ppm zinc, e.g., less than 22000 ppm, less than 20000 ppm, less than 15000 ppm, less than 12000 ppm, less than 10000 ppm, less than 7500 ppm, less than 5000 ppm, less than 3000 ppm, less than 2500 ppm, less than 2000 ppm, less than 1500 ppm, less than 1200 ppm, less than 1000 ppm, less than 750 ppm, less than 500 ppm, less than 250 ppm, less than 100 ppm, or less than 50 ppm.

In some cases, the wash solution has a particular pH. As noted above, pH has been found to unexpectedly improve zinc addition to the article. In some embodiments, the wash solution has a pH greater than 3.5, e.g., greater than 3.6, greater than 4.0, greater than 5.0 greater than 5.5, greater than 6.0, greater than 6.5, greater than 7.0, greater than 7.5, greater than 8.0, greater than 8.5, or greater than 9.0. In terms of upper limits, the wash solution may have a pH less than 10.5, e.g., less than 10.0, less than 9.5, less than 9.0, less than 8.5, less than 8.0, less than 7.5, less than 7.2, less than 7.0, less than 6.5, less than 6.0, less than 5.5, less than 5.0, or less than 4.5. In terms of ranges, the wash solution may have a pH ranging from 3.5 to 10.5, e.g., from 3.5 to 10.0, from 3.5 to 7.5, from 3.6 to 7.2, or from 4.0 to 6.0. The pH may be maintained by addition of acid, base, or buffer, as is well known in the art.

In some cases, the water is provided from a municipal source and may have the zinc content mentioned above (optionally after treatment of the municipal water). In some embodiments, the wash solution comprises water and an added zinc compound, which contributes to the aforementioned zinc content.

The zinc may be provided to the wash solution via a package of dissolvable film, such as a detergent pod. The wash solution may comprise the solution, e.g., water, and the (dissolved components of the) detergent pod, and optionally other components such as soap, water softeners, pH adjusters, and/or article/fabric softeners.

### Polymer Composition

The article (and the washed article) may be made from or may comprise a polymer composition, as discussed herein. The polymer composition comprises polymer and an AM/AV metal. Thus, the article may comprise polymer and AM/AV metal. Other processing aids may also be present in the polymer composition.

### Polymer

The polymer composition comprises a polymer, which, in some embodiments, is a polymer suitable for producing fibers and articles. In some cases, the polymer composition is formed into fibers, e.g., a monofilament fiber. These fibers may be woven into fabrics. In other cases, the monofilament fibers may be used for some applications, e.g., sutures. In one embodiment, the polymer composition comprises a polymer in an amount ranging from 50 wt. % to 100 wt. %, e.g., from 50 wt. % to 99.99 wt. %, from 50 wt. % to 99.9 wt. %, from 50 wt. % to 99 wt. % from 55 wt. % to 100 wt. %, from 55 wt. % to 99.99 wt. %, from 55 wt. % to 99.9 wt. %, from 55 wt. % to 99 wt. %, from 60 wt. % to 100 wt. %, from 60 wt. % to 99.99 wt. %, from 60 wt. % to 99.9 wt. %, from 60 wt. % to 99 wt. %, from 65 wt. % to 100 wt. %, from 65 wt. % to 99.99 wt. %, from 65 wt. % to 99.9 wt. %, or from 65 wt. % to 99 wt. %. In terms of upper limits, the polymer composition may comprise less than 100 wt. % of the polymer, e.g., less than 99.99 wt. %, less than 99.9 wt. %, or less than 99 wt. %. In terms of lower limits, the polymer composition may comprise greater than 50 wt. % of the polymer, e.g., greater than 55 wt. %, greater than 60 wt. %, or greater than 65 wt. %. In some cases, the composition comprises the zinc and other additives, as discussed herein, and the balance polymer.

The polymer of the polymer composition may vary widely. The polymer may include but is not limited to, a thermoplastic polymer, polyester, nylon, rayon, polyamide 6, polyamide 6,6, polyethylene (PE), polypropylene (PP), polyethylene terephthalate (PET), polyethylene terephthalate glycol (PETG), co-PET, polylactic acid (PLA), and polytrimethylene terephthalate (PTT). In some embodiments, the polymer composition may comprise PET, for its strength, longevity during washing, ability to be made permanent press, and ability to be blended with other fibers. In some embodiments, the polymer may be Nylon 6,6. In some cases, nylon is known to be a stronger fiber than PET and exhibits a non-drip burning characteristic that is beneficial e.g., in military or automotive textile applications, and is more hydrophilic than PET. The polymer used in the present disclosure can be a polyamide, polyether amide, polyether ester or polyether urethane or a mixture thereof.

In some cases, the polymer compositions may comprise polyethylene. Suitable examples of polyethylene include linear low-density polyethylene (LLDPE), low-density polyethylene (LDPE), medium-density polyethylene (MDPE), high-density polyethylene (HDPE), and ultra-high-molecular-weight polyethylene (UHMWPE).

In some cases, the polymer compositions may comprise polycarbonate (PC). For example, the polymer composition may comprise a blend of polycarbonate with other polymers, e.g., a blend of polycarbonate and acrylonitrile butadiene styrene (PC-ABS), a blend of polycarbonate and polyvinyl toluene (PC-PVT), a blend of polycarbonate and polybutylene terephthalate (PC-PBT), a blend of polycarbonate and polyethylene terephthalate (PC-PET), or combinations thereof.

In some cases, the polymer composition may comprise polyamides. Common polyamides include nylons and aramids. For example, the polyamide may comprise PA-4T/4I; PA-4T/6I; PA-5T/5I; PA-6; PA-6,6; PA-6,6/6; long chain polyamide (such as PA-10; PA-12; PA-6,10; PA-6,12, as well as other known long chain variants optionally including aromatic components, e.g., T and I components); PA-6,6/6T; PA-6T/6I; PA-6T/6I/6; PA-6T/6; PA-6T/6I/66; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-6T/61/12; and copolymers, blends, mixtures and/or other combinations thereof. Additional suitable polyamides, additives, and other components are disclosed in U.S. patent application Ser. No. 16/003,528. Such polymers may synergistically work well with the other components of the polymer composition due to the hydrophilic and/or hygroscopic properties thereof.

In one embodiment, the polymer comprises PA6, PA66, PA10, PA12, PA610, PA612, PA6T, or PA6I, or copolymers or terpolymers thereof. In some cases the polymer comprises PA66 or PA66/PA6 or combinations thereof.

The polymer compositions surprisingly may benefit from a polymer having high or increased hydrophilicity and/or possess hygroscopic properties. In particular, the use of a hydrophilic and/or hygroscopic polymer may increase the antiviral properties of the polymer composition. It is postulated that viruses and/or microbials are carried by liquids like saliva and mucous. Also, it is theorized that a polymer of increased hydrophilicity and/or hygroscopy both may better attract liquid media that carry microbials and/or viruses, e.g., saliva or mucous, and may also absorb more moisture, e.g., from the air, and that the increased moisture content allows the polymer composition and the antiviral/antimicrobial agent to more readily limit, reduce, or inhibit infection and/or pathogenesis of a virus. For example, the moisture may dissolve an outer layer, e.g., capsid, of a virus, exposing the genetic material, e.g., DNA or RNA, of the virus. The exposed genetic material is more susceptible to deactivation by other components of the polymer composition, e.g., the zinc compound, phosphorus compound, and/or copper compound (discussed below). This is one surprising, synergistic results of using polymers having higher levels of hydrophilicity and/or hygroscopy. In contrast, products formed from less hydrophilic and/or hygroscopic polymers, e.g., polypropylene, may not attract the fluids, and may not be as effective.

In some cases, conventional surface modifiers, such as citric acid, are applied to or sprayed on the surface of the polymer compositions (or of articles formed therefrom). By using a hydrophilic and/or hygroscopic polymer, the polymer compositions of the present disclosure may not require any such solubility modifiers.

In some other embodiments however, the products formed from the polymer compositions may be treated, e.g., with citric acid, to make them even more hydrophilic and/or hygroscopic.

In some cases, the hydrophilicity and/or hygroscopic properties of a polymer may be measured by saturation.

In some cases, the hydrophilicity and/or hygroscopy of a polymer may be measured by the amount of water it can absorb (as a percentage of total weight). In some embodiments, the hydrophilic and/or hygroscopic polymer is capable of absorbing greater than 1.5 wt % water, based on the total weight of the polymer, e.g., greater than 2.0 wt %, greater than 3.0%, greater than 5.0 wt %, or greater than 7.0 wt %. In terms of ranges, the hydrophilic and/or hygroscopic polymer may be capable of absorbing water in an amount ranging from 1.5 wt % to 10.0 wt %, e.g., from 1.5 wt % to 9.0 wt %, from 2.0 wt % to 8 wt %, from 2.0 wt % to 7 w %, of from 2.5 wt % to 7 wt. %. The ability to absorb more moisture allows the polymer compositions to better reduce or inhibit the growth of the microbials and/or viruses that are contained therein (as discussed above).

As noted above, some applications of the polymer compositions described herein surprisingly may benefit from increased hygroscopy. An increase in hygroscopy may be achieved in the selection and/or modification the polymer. In some embodiments, the polymer may be a common polymer, e.g., a common polyamide, which has been modified to increase hygroscopy. In these embodiments, a functional end group modification on the polymer may increase hygroscopy. For example, the polymer may be PA-6,6, which has been modified to include a functional endgroup that increases hygroscopy.

In some preferred cases, the polyamide-based, e.g., nylon-based, compounds are utilized as the polymer. It has surprisingly been found that these nylon-based polymers, when utilized with the aforementioned zinc compound, copper compound, and phosphorus compound additives and formed into articles, provide the antiviral and/or antimicrobial characteristics. In some cases, it has been found that conventional polymers that utilize polyester polymers harbor and allow to flourish different types of viruses and/or bacteria, as compared to those of nylon. For example, micrococcus bacteria have been found to flourish in polyester-based articles and produce high odor levels. Thus the use of nylon-based polymers, along with the aforementioned additives, surprisingly has been found to yield articles that demonstrate significantly low odor levels as compared to similar articles that utilize polyesters.

The polymer composition may, in some embodiments, comprise a combination of polyamides. By combining various polyamides, the final composition may be able to incorporate the desirable properties, e.g., mechanical properties, of each constituent polyamides. For example, in some embodiments, the polyamide comprises a combination of PA-6, PA-6,6, and PA-6,6/6T. In these embodiments, the polyamide may comprise from 1 wt. % to 99 wt. % PA-6, from 30 wt. % to 99 wt. % PA-6,6, and from 1 wt. % to 99 wt. % PA-6,6/6T. In some embodiments, the polyamide comprises one or more of PA-6, PA-6,6, and PA-6,6/6T. In some aspects, the polymer composition comprises 6 wt. % of PA-6 and 94 wt. % of PA-6,6. In some aspects, the polymer composition comprises copolymers or blends of any of the polyamides mentioned herein.

The polymer composition may also comprise polyamides produced through the ring-opening polymerization or polycondensation, including the copolymerization and/or copolycondensation, of lactams. Without being bound by theory, these polyamides may include, for example, those produced from propiolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the polymer composition may comprise the polyamides produced through the copolymerization of a lactam with a nylon, for example, the product of the copolymerization of a caprolactam with PA-6,6.

In some aspects, the polymer can formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the specific amounts of a zinc compound, a copper compound, and/or a phosphorus compound described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

In some embodiments, the polymer compositions (and the fibers/articles produced therefrom) advantageously comprise little or no content of processing aids such as surfactants and/or coupling agents (see discussion above). In some cases, the polymer compositions comprise less than 100 wppm surfactant and/or coupling agent, e.g., less than 50 wppm, less than less than 20 wppm, less than 10 wppm, or less than 5 wppm. In terms of ranges, the polymer compositions may comprise from 1 wppb to 100 wppm, e.g., from 1 wppb to 20 wppm, from 1 wppb to 10 wppm, or from 1 wppb to 5 wppm. The disclosed compositions may not employ any surfactant and/or coupling agent at all. There can be no surfactant and/or coupling agent present after processing, which is not the case for conventional formulations that do employ surfactant and/or coupling agents as necessary components. Even though some of these components may burn off during processing, some surfactant and/or coupling agent will remain in the resultant fibers.

Common surfactants include anionic surfactants, cationic surfactants and/or non-ionic surfactants. Specific examples are stearic acid, sodium dodecyl sulfonate surfactants, quaternary ammonium surfactants, amino acid surfactants, betaine surfactants, fatty acid glyceride ester surfactants, fatty acid sorbitan surfactants, lecithin surfactants, and/or Tween™ series surfactants (e.g., polyethoxylated sorbitan ester surfactants, nonionic polyoxyethylene surfactants, etc.).

The inventors have found that the content of amine end groups (AEG) may have a surprising effect on the performance of the polymer compositions, fibers, and articles. As one example, the AEGs have been found to improve the ability to dye fibers and/or articles. The polymer composition may have an AEG content ranging from 1 μeq/gram to 105 μeq/gram, e.g., from 1 μeq/gram to 75 μeq/gram, from 1 μeq/gram to 55 μeq/gram, from 5 μeq/gram to 50 μeq/gram, or from 15 μeq/gram to 40 μeq/gram. In terms of upper limits, the polymer composition may have an AEG content less than 105 μeq/gram, e.g., less than 100 μeq/gram, less than 90 μeq/gram, less than 75 μeq/gram, less than 55 μeq/gram, less than 50 μeq/gram, less than 45 μeq/gram, less than 40 μeq/gram, less than 35 μeq/gram, less than 30 μeq/gram, or less than 25 μeq/gram. In terms of lower limits, the polymer composition may have an AEG content greater than 1 μeq/gram, e.g., greater than 5 μeq/gram, greater than 10 μeq/gram, greater than 15 μeq/gram, greater than 20 μeq/gram, greater than 25 μeq/gram, greater than 35 μeq/gram, greater than 40 μeq/gram, or greater than 50 μeq/gram.

In some cases, e.g., when a spunbond process is employed, a higher relative viscosity may be employed. In other cases, e.g., when a meltblown process is employed, a lower relative viscosity may be employed. In these cases, the inventors have found that by using particular zinc and/or phosphorus content, along with specific polymer characteristics, unexpected efficiencies can be achieved, while also achieving AM/AV performance. Examples of some specific formulations are provided below.

### AM/AV (Zinc or Copper or Silver) Compound

### Zinc Compound

As noted above, the polymer composition includes an AM/AV metal, e.g., zinc, in an AM/AV compound, e.g., a zinc compound, and optionally phosphorus in a phosphorus compound, preferably in specific amounts in the polymer composition, to provide the aforementioned structural and antiviral benefits. As used herein, “zinc compound” refers to a compound having at least one zinc molecule or ion (likewise for copper compounds). As used herein, “phosphorus compound” refers to a compound having at least one phosphorus molecule or ion. Zinc content may be indicated by zinc or zinc ion (the same is true for copper). The ranges and limits may be employed for zinc content and for zinc ion content, and for other metal content, e.g., copper content. The calculation of zinc ion content based on zinc or zinc compound can be made by the skilled chemist, and such calculations and adjustments are contemplated.

The inventors have found that the use of specific zinc compounds (and the zinc contained therein) and optionally phosphorus compounds (and the phosphorus contained therein) at specific molar ratios minimizes the negative effects of the zinc compound on the polymer composition. For example, too much zinc compound in the polymer composition can lead to decreased polymer viscosity and inefficiencies in production processes.

The polymer composition may comprise zinc (e.g., in a zinc compound or as zinc ion), e.g., zinc or a zinc compound, dispersed within the polymer composition. In one embodiment, the polymer composition comprises zinc in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, 5000 wppm to 20000 wppm, from 200 wppm to 3000 wppm, from 200 wppm to 2000 wppm, from 200 wppm to 1000 wppm, from 200 wppm to 500 wppm, from 10 wppm to 900 wppm, from 200 wppm to 900 wppm, from 425 wppm to 600 wppm, from 425 wppm to 525 wppm, from 350 wppm to 600 wppm, from 375 wppm to 600 wppm, from 375 wppm to 525 wppm, from 480 wppm to 600 wppm, from 480 wppm to 525 wppm, from 600 wppm to 750 wppm, or from 600 wppm to 700 wppm.

In terms of lower limits, the polymer composition may comprise greater than 5 wppm of zinc, e.g., greater than 10 wppm, greater than 50 wppm, greater than 100 wppm, greater than 200 wppm, greater than 300 wppm, greater than 350 wppm, greater than 375 wppm, greater than 400 wppm, greater than 425 wppm, greater than 480 wppm, greater than 500 wppm, or greater than 600 wppm.

In terms of upper limits, the polymer composition may comprise less than 20,000 wppm of zinc, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1100 wppm, less than 1000 wppm, less than 500 wppm, less than 400 wppm, less than 330 wppm, less than 300. In some aspects, the zinc compound is embedded in the polymer formed from the polymer composition.

In some cases, the polymer composition may comprise less than 1,500 wppm of zinc, e.g., less than 1300 wppm, less than 1100 wppm, less than 1000 wppm, less than 900 wppm, less than 800 wppm, less than 700 wppm, less than 600 wppm, less than 500 wppm, less than 400 wppm, or less than 300 wppm. In certain cases, the lower concentrations of zinc, e.g., provided via zinc chloride, provide for beneficial cytotoxicity performance.

The ranges and limits are applicable to both zinc in elemental or ionic form and to zinc compound). The same is true for other ranges and limits disclosed herein relating to other metals, e.g., copper. For example, the ranges may relate to the amount of zinc ions dispersed in the polymer.

The ranges and limits for AM/AV content discussed herein are applicable as the initial AM/AV content of the article/polymer composition and/or as the washed zinc content of the washed article. As noted above, a benefit of the disclosed wet treatment process is that the washed zinc content will advantageously be greater than or equal to the initial zinc content.

The zinc of the polymer composition is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate.

The inventors have also found that the polymer compositions surprisingly may benefit from the use of specific zinc compounds. In particular, the use of zinc compounds prone to forming ionic zinc (e.g., Zn2+) may increase the antiviral properties of the polymer composition. It is theorized that the ionic zinc disrupts the replicative cycle of the virus. For example, the ionic zinc may interfere with (e.g., inhibit) viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLoS Pathogens (November 2010). Gopal et al., Zinc-Embedded Polyamide Fabrics Inactivate SARS-CoV-2 and Influenza A Virus, Appl. Materials Interface, Vol 13, (2021), which are incorporated herein by reference.

The amount of the zinc compound present in the polymer compositions may be discussed in relation to the ionic zinc content. In one embodiment, the polymer composition comprises ionic zinc, e.g., Zn2+, in an amount ranging from 1 ppm to 30,000 ppm, e.g., from 1 ppm to 25,000 ppm, from 1 ppm to 20,000 ppm, from 1 ppm to 15,000 ppm, from 1 ppm to 10,000 ppm, from 1 ppm to 5,000 ppm, from 1 ppm to 2,500 ppm, from 50 ppm to 30,000 ppm, from 50 ppm to 25,000 ppm, from 50 ppm to 20,000 ppm, from 50 ppm to 15,000 ppm, from 50 ppm to 10,000 ppm, from 50 ppm to 5,000 ppm, from 50 ppm to 2,500 ppm, from 100 ppm to 30,000 ppm, from 100 ppm to 25,000 ppm, from 100 ppm to 20,000 ppm, from 100 ppm to 15,000 ppm, from 100 ppm to 10,000 ppm, from 100 ppm to 5,000 ppm, from 100 ppm to 2,500 ppm, from 150 ppm to 30,000 ppm, from 150 ppm to 25,000 ppm, from 150 ppm to 20,000 ppm, from 150 ppm to 15,000 ppm, from 150 ppm to 10,000 ppm, from 150 ppm to 5,000 ppm, from 150 ppm to 2,500 ppm, from 250 ppm to 30,000 ppm, from 250 ppm to 25,000 ppm, from 250 ppm to 20,000 ppm, from 250 ppm to 15,000 ppm, from 250 ppm to 10,000 ppm, from 250 ppm to 5,000 ppm, or from 250 ppm to 2,500 ppm. In some cases, the ranges and limits mentioned above for zinc may also be applicable to ionic zinc content.

In some cases, the use of zinc provides for processing and or end use benefits. Other antiviral agents, e.g., copper or silver, may be used, but these often include adverse effects (e.g., on the relative viscosity of the polymer composition, toxicity, and health or environmental risk). In some situations, the zinc does not have adverse effects on the relative viscosity of the polymer composition. Also, the zinc, unlike other antiviral agents, e.g., silver, does not present toxicity issues (and in fact may provide health advantages, such as immune system support). In addition, as noted herein, the use of zinc provides for the reduction or elimination of leaching into other media and/or into the environment. This both prevents the risks associated with introducing zinc into the environment and allows the polymer composition to be reused—zinc provides surprising “green” advantages over conventional, e.g., silver-containing, compositions.

### Copper Compound

As noted above, the polymer composition, in some embodiments, includes copper (provided via a copper compound). As used herein, “copper compound” refers to a compound having at least one copper molecule or ion.

In some cases, the copper compound may improve, e.g., enhance the antiviral properties of the polymer composition. In some cases, the copper compound may affect other characteristics of the polymer composition, e.g., antimicrobial activity or physical characteristics.

The polymer composition may comprise copper (e.g., in a copper compound), e.g., copper or a copper compound, dispersed within the polymer composition. In one embodiment, the polymer composition comprises copper in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 5 wppm to 100 wppm, from 5 wppm to 50 wppm, from 5 wppm to 35 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of copper, e.g., greater than 10 wppm, greater than 50 wppm, greater than 100 wppm, greater than 200 wppm, or greater than 300 wppm. In terms of upper limits, the polymer composition may comprise less than 20,000 wppm of copper, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm less than 100 wppm, less than 50 wppm, less than 35 wppm. In some aspects, the copper compound is embedded in the polymer formed from the polymer composition.

The composition of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate.

In some cases, the polymer composition includes silver (optionally provided via a silver compound). As used herein, “silver compound” refers to a compound having at least one silver molecule or ion. The silver may be in ionic form. The ranges and limits for silver may be similar to the ranges and limits for copper (discussed above).

In one embodiment, the molar ratio of the copper to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to copper in the polymer composition may be less than 15:1, e.g., less than 10:1, less than 9:1, less than 8:1, less than 7:1, less than 6:1, less than 5:1, less than 4:1, or less than 3:1. In some cases, copper is bound in the polymer matrix along with zinc.

In some embodiments, the use of cuprous ammonium adipate has been found to be particularly effective in activating copper ions into the polymer matrix. Similarly, the use of silver ammonium adipate has been found to be particularly effective in activating silver ions into the polymer matrix. It is found that dissolving copper (I) or copper (II) compounds in ammonium adipate is particularly efficient at generating copper (I) or copper (II) ions. The same is true for dissolving Ag (I) or Ag (III) compounds in ammonium adipate to generate Ag1+ or Ag3+ ions.

Similarly, silver compounds may also be employed as an AM/AV metal, with the aforementioned ligands and in the aforementioned amounts. Other AM/AV metals are also contemplated.

### Phosphorus Compound

The polymer composition may comprise phosphorus (in a phosphorus compound), e.g., phosphorus or a phosphorus compound is dispersed within the polymer composition. In one embodiment, the polymer composition comprises phosphorus in an amount ranging from 50 wppm to 10000 wppm, e.g., from 50 wppm to 5000 wppm, from 50 wppm to 2500 wppm, from 50 wppm to 2000 wppm, from 50 wppm to 800 wppm, 100 wppm to 750 wppm, 100 wppm to 1800 wppm, from 100 wppm to 10000 wppm, from 100 wppm to 5000 wppm, from 100 wppm to 2500 wppm, from 100 wppm to 1000 wppm, from 100 wppm to 800 wppm, from 200 wppm to 10000 wppm, 200 wppm to 5000 wppm, from 200 wppm to 2500 wppm, from 200 ppm to 800 wppm, from 300 wppm to 10000 wppm, from 300 wppm to 5000 wppm, from 300 wppm to 2500 wppm, from 300 wppm to 500 wppm, from 500 wppm to 10000 wppm, from 500 wppm to 5000 wppm, or from 500 wppm to 2500 wppm. In terms of lower limits, the polymer composition may comprise greater than 50 wppm of phosphorus, e.g., greater than 75 wppm, greater than 100 wppm, greater than 150 wppm, greater than 200 wppm greater than 300 wppm or greater than 500 wppm. In terms of upper limits, the polymer composition may comprise less than 10000 wppm (or 1 wt. %), e.g., less than 5000 wppm, less than 2500 wppm, less than 2000 wppm, less than 1800 wppm, less than 1500 wppm, less than 1000 wppm, less than 800 wppm, less than 750 wppm, less than 500 wppm, less than 475 wppm, less than 450 wppm, less than 400 wppm, less than 350 wppm, less than 300 wppm, less than 250 wppm, less than 200 wppm, less than 150 wppm, less than 100 wppm, less than 50 wppm, less than 25 wppm, or less than 10 wppm.

In some aspects, the phosphorus or the phosphorus compound is embedded in the polymer formed from the polymer composition. As noted above, because of the overall make-up of the disclosed composition low amounts, if any, phosphorus may be employed, which in some cases may provide for advantageous performance results (see above).

The phosphorus of the polymer composition is present in or provided via a phosphorus compound, which may vary widely. The phosphorus compound may comprise bezene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylmethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, and combinations thereof. In some embodiments, the phosphorus compound comprises phosphoric acid, benzene phosphinic acid, or benzene phosphonic acid, or combinations thereof. In some embodiments, the phosphorus compound comprises benzene phosphinic acid, phosphorous acid, or manganese hypophosphite, or combinations thereof. In some aspects, the phosphorus compound may comprise benzene phosphinic acid.

In one embodiment, the molar ratio of the phosphorus to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the phosphorus to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to phosphorus in the polymer composition may be less than 15:1, e.g., less than 10:1, less than 9:1, less than 8:1, less than 7:1, less than 6:1, less than 5:1, less than 4:1, or less than 3:1. In some cases, phosphorus is bound in the polymer matrix along with zinc.

In one embodiment, the weight ratio of zinc to phosphorus in the polyamide composition may be greater than 1.3:1, e.g., greater than 1.4:1, greater than 1.5:1, greater than 1.6:1, greater than 1.7:1, greater than 1.8:1, or greater than 2:1. In terms of ranges, the weight ratio of zinc to phosphorus in the polyamide composition may range from 1.3:1 to 30:1, e.g., from 1.4:1 to 25:1, from 1.5:1 to 20:1, from 1.6:1 to 15:1, from 1.8:1 to 10:1, from 2:1 to 8:1, from 3:1 to 7:1, or from 4:1 to 6:1. In terms of upper limits, the weight ratio of zinc to phosphorus in the polyamide composition may be less than 30:1, e.g., less than 28:1, less than 26:1, less than 24:1, less than 22:1, less than 20:1, or less than 15:1. In some aspects, there is no phosphorus in the polyamide composition. In other aspects, a very low amount of phosphorus is present. In some cases, phosphorus is held in the polymer matrix along with zinc.

In one embodiment, the weight ratio of zinc to phosphorus in the polyamide composition may be less than 0.64:1, e.g., less than 0.62:1, less than 0.6:1, e.g., less than 0.5:1, less than 0.45:1, less than 0.4:1, less than 0.3:1, or less than 0.25:1. In terms of ranges, the weight ratio of zinc to phosphorus in the polyamide composition may range from 0.001:1 to 0.64:1, e.g., from 0.01:1 to 0.6:1, from 0.05:1 to 0.5:1, from 0.1:1 to 0.45:1, from 0.2:1 to 0.4:1, from 0.25:1 to 0.35:1, or from 0.2:1 to 0.3:1. In terms of lower limits, the weight ratio of zinc to phosphorus in the polyamide composition may be greater than 0.001:1, e.g., greater than 0.005:1, greater than 0.01:1, greater than 0.05:1, greater than 0.1:1, greater than 0.15:1, or greater than 0.2:1.

Advantageously, it has been discovered that adding the above identified zinc compounds and phosphorus compounds may result in a beneficial relative viscosity (RV) of the polymer composition. In some embodiments, the RV of the polymer composition ranges from 5 to 80, e.g., from 5 to 70, from 10 to 70, from 15 to 65, from 20 to 60, from 30 to 50, from 10 to 35, from 10 to 20, from 60 to 70, from 50 to 80, from 40 to 50, from 30 to 60, from 5 to 30, or from 15 to 32. In terms of lower limits, the RV of the polymer composition may be greater than 5, e.g., greater than 10, greater than 15, greater than 20, greater than 25, greater than 27.5, or greater than 30. In terms of upper limits, the RV of the polymer composition may be less than 70, e.g., less than 65, less than 60, less than 50, less than 40, or less than 35.

To calculate RV, a polymer may be dissolved in a solvent (usually formic or sulfuric acid), the viscosity is measured, then the viscosity is compared to the viscosity of the pure solvent. This give a unitless measurement. Solid materials, as well as liquids, may have a specific RV. The fibers/articles produced from the polymer compositions may have the aforementioned relative viscosities, as well.

It has been determined that a specific amount of the zinc compound and the phosphorus compound can be mixed in a polymer composition, e.g., polyamide composition, in finely divided form, such as in the form of granules, flakes and the like, to provide a polymer composition that can be subsequently formed, e.g., extruded, molded or otherwise drawn, into various products (e.g., high-contact products, surface layers of high-contact products) by conventional methods to produce products having substantially improved antimicrobial activity. The zinc and phosphorus are employed in the polymer composition in the aforementioned amounts to provide a fiber with improved antimicrobial activity retention (near-permanent).

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

These components mentioned herein may be considered optional. In some cases, the disclosed compositions may expressly exclude one or more of the aforementioned components in this section, e.g., via claim language. For example claim language may be modified to recite that the disclosed compositions, processes, etc., do not utilize or comprise one or more of the aforementioned components, e.g., the compositions do not include a leveling agent.

### Performance

The articles disclosed herein will be made from the aforementioned polymer compositions and will have AM/AV properties associated therewith. AM/AV properties are discussed herein. These AM/AV properties are applicable to the polymer composition and to the fibers/articles made from the polymer compositions.

### Antiviral Activity

The polymer compositions described herein exhibit antiviral properties, e.g., antiviral activity. Furthermore, the fibers, articles, nonwoven polymer structures, and other products formed from the polymer compositions may also exhibit antiviral properties. In particular, by utilizing a polymer composition having the aforementioned zinc, copper, silver and/or phosphorus compounds in the disclosed concentrations, a polymer composition exhibiting antiviral properties can be prepared.

In some embodiments, the polymer compositions, and the products formed therefrom, exhibit permanent, e.g., near permanent, antiviral properties. Said another way, the antiviral properties of the polymer composition last for a prolonged period of time, e.g., longer than one or more day, longer than one or more week, longer than one or more month, or longer than one or more years.

The antiviral properties may include any antiviral effect. In some embodiments, for example, the antiviral properties of the polymer composition include limiting, reducing, or inhibiting infection of a virus. In some embodiments, the antiviral properties of the polymer composition include limiting, reducing, or inhibiting pathogenesis of a virus. In some cases, the polymer composition may limit, reduce, or inhibit both infection and pathogenesis of a virus.

The virus affected by the antiviral properties of the polymer composition is not particularly limited. In some embodiments, for example, the virus is an adenovirus, a herpesvirus, an ebolavirus, a poxvirus, a rhinovirus, a coxsackievirus, an arterivirus, an enterovirus, a morbillivirus, a coronavirus, an influenza A virus, an avian influenza virus, a swine-origin influenza virus, or an equine influence virus. In some embodiments, the antiviral properties include limiting, reducing, or inhibiting the infection or pathogenesis of one of virus, e.g., a virus from the above list. In some embodiments, the antiviral properties include limiting, reducing, or inhibiting the infection or pathogenesis of multiple viruses, e.g., a combination of two or more viruses from the above list.

In some cases, the virus is a coronavirus, e.g., severe acute respiratory syndrome coronavirus (SARS-CoV), Middle East respiratory syndrome coronavirus (MERS-CoV), or severe acute respiratory syndrome coronavirus 2 (SARS-CoV-2) (e.g., the coronavirus that causes COVID-19). In some cases, the virus is structurally related to a coronavirus.

In some cases, the virus is an influenza virus, such as an influenza A virus, an influenza B virus, an influenza C virus, or an influenza D virus, or a structurally related virus. In some cases, the virus is identified by an influenza A virus subtype, e.g., H1N1, H1N2, H2N2, H2N3, H3N1, H3N2, H3N8, H5N1, H5N2, H5N3, H5N6, H5N8, H5N9, H6N1, H7N1, H7N4, H7N7, H7N9, H9N2, or H10N7.

In some cases, the virus is a the virus is a bacteriophage, such as a linear or circular single-stranded DNA virus (e.g., phi X 174 (sometimes referred to as ΦX174)), a linear or circular double-stranded DNA, a linear or circular single-stranded RNA, or a linear or circular double-stranded RNA. In some cases, the antiviral properties of the polymer composition may be measured by testing using a bacteriophage, e.g., phi X 174.

In some cases, the virus is an ebolavirus, e.g., Bundibugyo ebolavirus (BDBV), Reston ebolavirus (RESTV), Sudan ebolavirus (SUDV), Taï Forest ebolavirus (TAFV), or Zaire ebolavirus (EBOV). In some cases, the virus is structurally related to an ebolavirus.

The antiviral activity may be measured by a variety of conventional methods. For example, ISO 18184 (2019) may be utilized to assess the antiviral activity. In one embodiment, the polymer composition, e.g., a fiber, yarn, article, and/or nonwoven polymer structure formed from the polymer composition inhibits the pathogenesis (e.g., growth) of a virus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, a fiber formed from the polymer composition may inhibit greater than 60% of pathogenesis of the virus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In some cases, the efficacy may be measured in term of log reduction. For example, the composition/fibers/articles may demonstrate a virus log reduction greater than 1.0, as determined via ISO 18184 (2019), e.g., greater than 1.5, greater than 1.7, greater than 1.9, greater than 2.0, greater, than 3.0, greater than 4.0, or greater than 5.0.

### Antimicrobial Activity

In some embodiments, the polymer compositions, and the products formed therefrom, may also exhibit antimicrobial activity. In some cases, the antimicrobial activity may be the result of an additional antimicrobial additive, as described below, or a result of the polymer composition itself. In some embodiments, the polymer compositions, and the products formed therefrom, exhibit permanent, e.g., near permanent, antimicrobial properties. Said another way, the antimicrobial properties of the polymer composition last for a prolonged period of time, e.g., longer than one or more day, longer than one or more week, longer than one or more month, or longer than one or more years.

The antimicrobial properties may include any antimicrobial effect. In some embodiments, for example, the antimicrobial properties of the polymer composition include limiting, reducing, or inhibiting infection of a microbe, e.g., a bacterium or bacteria. In some embodiments, the antimicrobial properties of the polymer composition include limiting, reducing, or inhibiting growth and/or killing a bacterium. In some cases, the polymer composition may limit, reduce, or inhibit both infection and growth of a bacterium.

The bacterium or bacteria affected by the antiviral properties of the polymer composition is not particularly limited. In some embodiments, for example, the bacterium is a Streptococcus bacterium (e.g., Streptococcus pneumonia, Streptococcus pyogenes), a Staphylococcus bacterium (e.g., Staphylococcus aureus (S. aureus), Methicillin-resistant Staphylococcus aureus (MRSA)), a Peptostreptococcus bacteria (e.g., Peptostreptococcus anaerobius, Peptostreptococcus asaccharolyticus), or a Mycobacterium bacterium, (e.g., Mycobacterium tuberculosis), a Mycoplasma bacteria (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae). In some embodiments, the antiviral properties include limiting, reducing, or inhibiting the infection or pathogenesis of multiple bacteria, e.g., a combination of two or more bacteria from the above list.

The antimicrobial activity may be measured by the standard procedure defined by ISO 20743:2013. This procedure measures antimicrobial activity by determining the percentage of a given bacterium or bacteria, e.g. S. aureus, inhibited by a tested fiber. In one embodiment, fibers formed from the polymer composition inhibit the growth (growth reduction) of Staphylococcus aureus in an amount ranging from 60% to 100%, e.g., from 60% to 99.999999%, from 60% to 99.999990%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.999990%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, a fiber formed from the polymer composition may inhibit greater than 60% growth of S. aureus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In some embodiments, the antiviral fibers (or the yarns or articles made therefrom) inhibit/reduce Staph aureus activity, as measured by ISO 20743:2013, by greater than 85%, e.g., greater than 86%, greater than 89%, greater than 90%, greater than 92%, greater than 95%, greater than 97%, greater than 98%, greater than 99%, greater than 99.5%, greater than 99.9%, greater than 99.99%, greater than 99.999%, greater than 99.9999%, greater than 99.99999%, or greater than 99.999999%.

In some embodiments, the antiviral fibers (or the yarns or articles made therefrom) inhibit/reduce Staph aureus activity (colony forming units per milliliter), as measured by ASTM E35.15 WK45351 (or ASTM E3160 (2018)), where the yarn may be “as spun.” The test may be modified to employ a single specimen (1.5 grams), 15 ml neutralizer. In such cases, the antiviral fibers (or the yarns or articles made therefrom) inhibit/reduce Staph aureus activity by greater than 13%, e.g., greater than 25%, greater than 50%, greater than 75%, greater than 80%, greater than 85%, greater than 90%, or greater than 92%.

In some embodiments, the antiviral fibers (or the yarns or articles made therefrom) inhibit/reduce Staph aureus activity (colony forming units per milliliter), as measured by ASTM E35.15 WK45351, where the yarn may be spun into yarn, extracted with acetone, and then extracted using boiling water for one hour. In such cases, the antiviral fibers (or the yarns or articles made therefrom) inhibit/reduce Staph aureus activity by greater than 75%, e.g., greater than 80%, greater than 85%, greater than 90%, greater than 95%, greater than 97%, greater than 98%, greater than 99%, greater than 99.9%, greater than 99.99%, greater than 99.999%, greater than 99.9999%, greater than 99.99999%, or greater than 99.999999%.

In some embodiments, the antiviral fibers (or other antiviral products) inhibit/reduce Staph aureus activity (colony forming units per milliliter), as measured by ASTM E2149, where the yarn may be “as spun.” The test may be modified to employ a single specimen (1.5 grams), 20 ml inoculum, an 8 hour incubation time. In such cases, the antiviral fibers (or other antiviral products) inhibit/reduce Staph aureus activity by greater than 50%, e.g., greater than 75%, greater than 85%, greater than 90%, greater than 95%, greater than 97%, greater than 97.5%, greater than 97.8%, greater than 98%, greater than 99%, greater than 99.9%, greater than 99.99%, greater than 99.999%, greater than 99.9999%, greater than 99.99999%, or greater than 99.999999%.

In some embodiments, the antiviral fibers (or other antiviral products) inhibit/reduce Staph aureus activity (colony forming units per milliliter), as measured by ASTM E2149, where the fibers may be spun into yarn, extracted with acetone, and then extracted using boiling water for one hour. The test may be modified to employ a single specimen (1.5 grams), 20 ml inoculum, an 8 hour incubation time. In such cases, the antiviral fibers (or other antiviral products) inhibit/reduce Staph aureus activity by greater than 50%, e.g., greater than 55%, greater than 60%, greater than 63%, greater than 75%, greater than 80%, greater than 85%, greater than 90%, greater than 92%, greater than 95%, greater than 97%, greater than 98%, greater than 99%, greater than 99.9%, greater than 99.99%, greater than 99.999%, greater than 99.9999%, greater than 99.99999%, or greater than 99.999999%.

Efficacy may be characterized in terms of log reduction. In terms of Staph aureus log reduction, the composition/fibers/articles may be determined via ISO 20743:2013 and may demonstrate a microbial log reduction greater than 0.8, e.g., greater than 1.0, greater than 1.5. greater than 2.0, greater than 2.5, greater than 3.0, greater than 4.0, greater than 5.0, or greater than 6.0.

In terms of Staph aureus log reduction, the composition/fibers/articles may be determined via ASTM E3160 (2018) and may demonstrate a microbial log reduction greater than 0.6, e.g., greater than 0.8, greater than 1.0, greater than 1.5. greater than 2.0, greater than 2.5, greater than 3.0, greater than 4.0, greater than 5.0, or greater than 6.0.

In terms of Staph aureus log reduction, the composition/fibers/articles may be determined via AATCC TM100 (2018) and may demonstrate a microbial log reduction greater than 3.0, e.g., greater than 3.5, greater than 4.0. greater than 5.5, or greater than 6.0.

The antimicrobial activity of a fiber (or other products) formed from the polymer composition may also be measured by determining the percentage of another bacterium or bacteria, e.g. Klebsiella pneumoniae, inhibited by a tested fiber. In one embodiment, a fiber formed from the polymer composition inhibits the growth (growth reduction) of Klebsiella pneumoniae in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 100%, from 65% to 99.999999%, from 65% to 99.99999%, from 65% to 99.9999%, from 65% to 99.999% from 65% to 99.999%, from 65% to 99.99%, from 65% to 99.9%, from 65% to 99%, from 65% to 98%, from 65% to 95%, from 70% to 100%, from 70% to 99.9999990%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.999999%, from 75% to 99.999990%, from 75% to 99.9999%, from 75% to 99.999% from 75% to 99.999%, from 75% to 99.99%, from 75% to 99.9%, from 75% to 99%, from 75% to 98%, from 75% to 95%, %, from 80% to 100%, from 80% to 99.999999%, from 80% to 99.99999%, from 80% to 99.9999%, from 80% to 99.999% from 80% to 99.999%, from 80% to 99.99%, from 80% to 99.9%, from 80% to 99%, from 80% to 98%, or from 80% to 95%. In terms of upper limits, a fiber formed from the polymer composition may inhibit less than 100% growth of Klebsiella pneumoniae, e.g., less than 99.99%, less than 99.9%, less than 99%, less than 98%, or less than 95%. In terms of lower limits, a fiber formed from the polymer composition may inhibit greater than 60% growth of Klebsiella pneumoniae, e.g., greater than 65%, greater than 70%, greater than 75%, or greater than 80%, greater than 85%, greater than 90%, greater than 95%, greater than 99%, greater than 99.9%, greater than 99.99%, greater than 99.999%, greater than 99.9999%, greater than 99.99999%, or greater than 99.999999%.

In some embodiments, antiviral fibers formed from the polymer composition inhibit or reduce Klebsiella pneumoniae activity. The antiviral fibers (or other antiviral products) inhibit/reduce Klebsiella pneumoniae activity, as measured by ISO 20743:2013, by greater than 76.1%, e.g., greater than 77%, greater than 80%, greater than 85%, greater than 90%, greater than 92%, greater than 95%, greater than 97%, greater than 98%, greater than 99%, greater than 99.5%, greater than 99.9%, greater than 99.99%, greater than 99.999%, greater than 99.9999%, greater than 99.99999%, or greater than 99.999999%.

Escherichia coli and/or Klebsiella pneumoniae efficacy may also be determined using the aforementioned tests. In some embodiments, a product formed from the polymer composition inhibits the growth (growth reduction) of Escherichia coli and/or Klebsiella pneumoniae, as measured by the test mentioned above. The ranges and limits for Staph aureus are applicable to Escherichia coli and/or Klebsiella pneumoniae as well.

In terms of Klebsiella pneumoniae log reduction, the composition/fibers/articles may be determined via ISO 20743:2013 and may demonstrate a microbial log reduction greater than 0.8, e.g., greater than 0.9, greater than 1.0, greater than 1.2, greater than 1.4, greater than 1.5. greater than 2.0, greater than 2.15, greater than 2.5, greater than 2.7, greater than 3.0, greater than 3.3, greater than 4.0, greater than 5.0, or greater than 6.0.

In terms of Escherichia coli log reduction, the composition/fibers/articles may be determined via ASTM E3160 (2018) and may demonstrate a microbial log reduction greater than 1.5, e.g., greater than 2.0, greater than 2.15, greater than 2.5, greater than 2.7, greater than 3.0, greater than 3.3, greater than 4.0, greater than 5.0, or greater than 6.0.

The washed article demonstrates an AM/AV log reduction increase of at least 1.0 over that of the initial article, e.g., at least 1.5, at least 2.0, at least 2.5, at least 3.0, at least 3.5, at least 4.0, at least 4.5, or at least 5.0.

### EXAMPLES

Example fabrics 1-4 and Comparative fabrics A and B were prepared from polymer compositions using a spunbond process. Examples 1-3 and Comparative Examples A and B were spun into fibers, and the fibers were woven into fabrics. Example 4 was spunbond into a fabric. Example 5 was spun into a monofilament fiber and treated in this form (Example 5 was not spun into a fabric). The fabrics and fiber were then treated by maintaining the fabrics in a wash solution comprising water and ˜20 ppm zinc (from ZnO) for up to 25 wash cycles. Compositions of the polymer composition of the fabrics/fibers are provided in Table 1.

TABLE 1
Polymer Compositions

| | Ex. 1 | Ex. 2 | Ex. 3 | Ex. 4 | Ex. 5 | Comp. A | Comp B. |
|---|---|---|---|---|---|---|---|
| Polymer | PA66 | PA66 | PA66 | PA66 | PA66 | PA66 | PA66 |
| Zinc | 183 ppm | 425 | 181 | 424 | 464 | — | — |
| Compound | (ZnO) | PPm | PPm | PPm | PPm | | |
| | | (ZnO) | (ZnO) | (ZnO) | (ZnCl₂) | | |
| Dye Color | black | griege | black | — | black | black | griege |
| Solute | water | water | water | water | water | water | water |

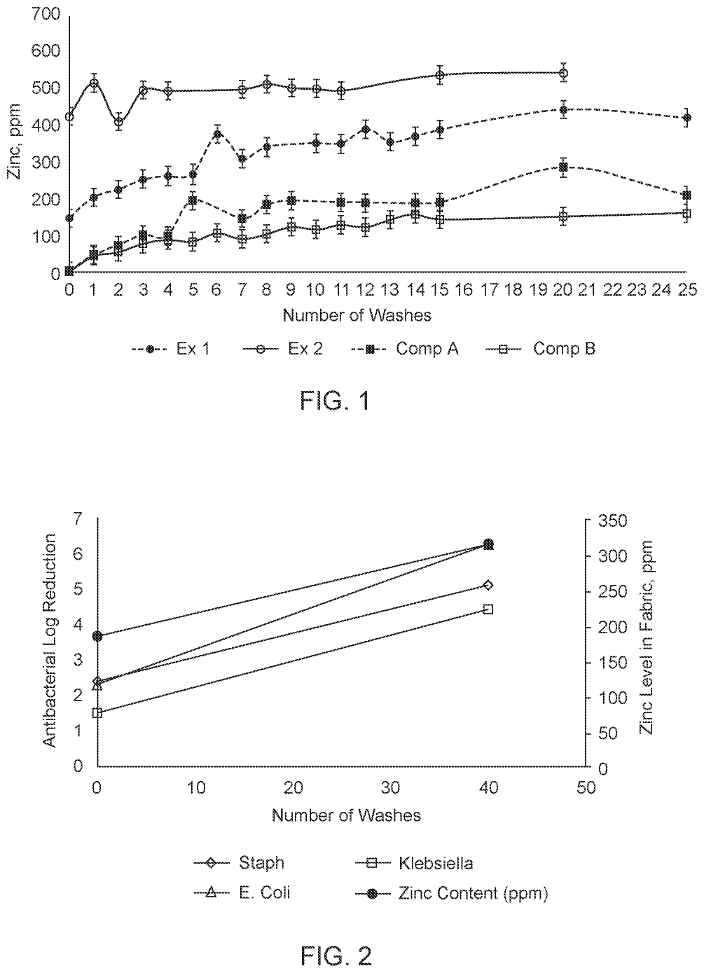

Examples 1 and 2 and Comparative Examples A and B were tested for zinc content after each wash cycle. The results are shown in FIG. 1. As shown, final zinc concentration after 25 wash cycles was significantly higher than the initial concentration. For example, Example 1 increased to approximately 400 ppm (from 183 ppm), and Example 2 (after only 20 washes) increased to 550 ppm (from 425 ppm). These increases are significantly higher than expected, especially in view of the small amount of zinc present in the wash solution (˜20 ppm zinc). Notably, the increase in zinc content is greater than the zinc content in the wash solution, e.g., greater than 20 ppm zinc. Comparative Examples A and B also demonstrated a zinc content increase, thus demonstrating the ability of the treatment to add zinc content to the base fabric fiber even when the article did not initially contain zinc. In cases where high zinc content is desired the combination of a starting zinc content and an added treatment zinc content provides for zinc content that was not previously achievable.

The fabric of Example 3 was treated for 40 wash cycles. The AM/AV (Klebsiella pneumonia, Staph aureus, and Escherichia coli) performance of Example 1 was measured after 40 wash cycles, under the testing parameters disclosed herein (ISO 20743 and ASTM E3160). Over the 40 wash cycles, the zinc concentration increased from 181 ppm to 320 ppm. Generally speaking, the log reduction performance improved by 2.5-3.0 log measurements. In particular, Example 3 demonstrated a Klebsiella pneumonia log reduction of 4.4; a Staph aureus log reduction of 5.1, and an Escherichia coli log reduction of 6.3, all of which were significant and surprising performance increases based on the initial AM/AV performance. These results demonstrate that zinc added via treatment provides for improvements in AM/AV performance.

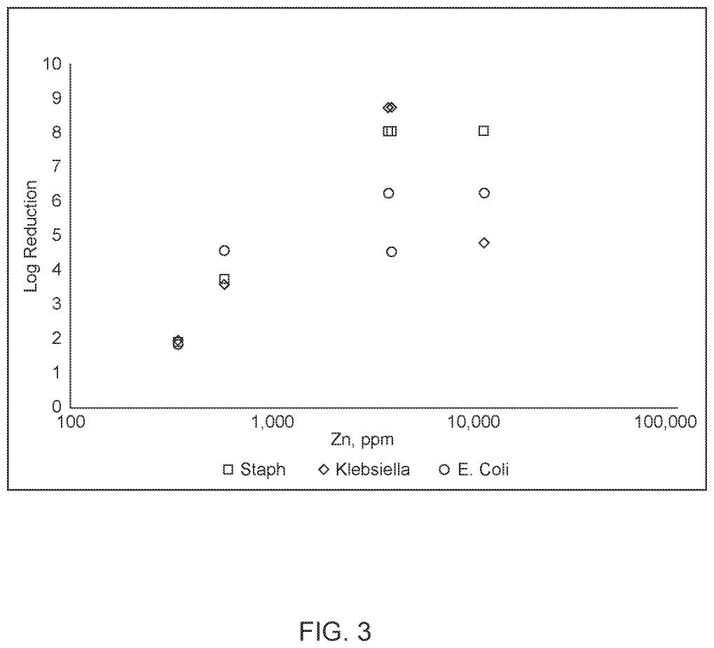

Additional sample fabrics/fibers of Examples 1-5 were treated using wash solutions varying from 20 ppm to 20,000 ppm until zinc concentrations of 500 ppm, 750 ppm, 6000 ppm, and 11000 ppm were achieved. The AM/AV performance, Klebsiella pneumonia, Staph aureus, and Escherichia coli, was tested at these levels. The AM/AV performance is shown in FIG. 3. This experiment shows that the disclosed process advantageously adds significant zinc content to a fabric and that the additional zinc content provides for beneficial improvements in AM/AV performance.

Example fabrics 6-9 were prepared (initial zinc content of 424 ppm). Example fabrics 6-9 were treated in various wash solutions comprising water and 20 ppm, 50 ppm, 2000 ppm, and 20000 ppm zinc (from ZnCl₂). The Example fabrics were treated for 45 minutes (at 49° C.). Zinc contents of the fabrics and Staph aureus performance were tested after treatment. The results are shown in Table 2. As shown, Staph aureus performance increased significantly (up to ˜8 log reduction) as zinc content of the fabric increases.

TABLE 2

| | Wash Sol. | Zn | Staph Log |
|---|---|---|---|
| | Zn Content | (post-treatment) | Reduction |
| Ex. 6 | 20 | 427 | 8.1 |
| Ex. 7 | 200 | 480 | 8.0 |
| Ex. 8 | 2000 | 1200 | 7.9 |
| Ex. 9 | 20000 | 4181 | 8.1 |

Example fabric 10 was prepared (initial zinc content of 424 ppm). A wash solution comprising water, zinc oxide (initially solid), and 0.31M sodium hydroxide was also prepared. The wash solution had a resultant zinc concentration of 3100 ppm. Example fabric 10 was treated in the wash solution. Zinc contents of the fabric were measured after treatment for various time periods. The results are shown in Table 3. As shown, zinc content increased significantly treatment time increased. This experiment demonstrates that multiple zinc (zinc ion) sources may be employed to achieve the disclosed results.

TABLE 3

| | Zn, | Zn, | Zn, | Zn, |
|---|---|---|---|---|
| | 15 mins | 30 mins | 45 mins | 60 mins |
| Ex. 10 | 631 | 801 | 846 | 1050 |

Example monofilament 5 was prepared as discussed above (initial zinc content of 464 ppm; black dye added). Two wash solutions were prepared: 241.1 g of 10% ZnCl₂+258.9 g water (final Zn concentration of 23,980 ppm) and 487.5 g of 10% ZnCl₂+212.5 g water (final Zn concentration of 47,961 ppm). Example 5 was treated in the wash solutions for 45 minutes (at 49° C.). Zinc contents of the filaments were measured after treatment. When treated with the 23,980 ppm solution, Example 5 demonstrated a final zinc content of 898 ppm, a 94% increase. When treated with the 48,961 ppm solution, Example 5 demonstrated a final zinc content of 1398 ppm, a 201% increase. This experiment demonstrates that different articles may be treated as disclosed herein to achieve the aforementioned results.

### EMBODIMENTS

The following embodiments are contemplated. All combinations of features and embodiments are contemplated.

Embodiment 1: a wet treatment process, the process comprising adding an article comprising a polymer and an initial AM/AV metal content, e.g., and initial zinc content, to a wash solution comprising a solute, e.g., water, and a wash solution AM/AV metal content, e.g., a wash solution zinc content; maintaining the article in the wash solution for a wash time greater than 10 seconds to yield a washed article comprising a washed AM/AV metal content, e.g., a washed zinc content; wherein the washed AM/AV metal content is greater than the initial AM/AV metal content; and wherein the washed article optionally demonstrates a Klebsiella pneumonia log reduction greater than 0.90, as determined via ISO20743:2013 and/or an Escherichia coli log reduction greater than 1.5, as determined via ASTM E3160 (2018).

Embodiment 2: an embodiment of embodiment 1, wherein the washed AM/AV metal content is at least 10% greater than the initial AM/AV metal content.

Embodiment 3: an embodiment of embodiment 1 or 2, wherein the difference between the washed AM/AV metal content and the initial AM/AV metal content is greater than the wash solution AM/AV metal content.

Embodiment 4: an embodiment of embodiments 1-3, wherein the washed AM/AV metal content is greater than the wash solution AM/AV metal content.

Embodiment 5: an embodiment of embodiments 1-4, wherein the washed article demonstrates a log reduction increase of at least 1.0 over the log reduction of the article.

Embodiment 6: an embodiment of embodiments 1-5, wherein the polymer comprises PA6, PA66, PA10, PA12, PA6T, or PA6I, or copolymers or terpolymers thereof.

Embodiment 7: an embodiment of embodiments 1-6, wherein the wash solution comprises from 200 ppm to 22000 ppm or from 1 ppb to 100 ppm zinc.

Embodiment 8: an embodiment of embodiments 1-7, wherein the wash solution has a pH greater than 3.5.

Embodiment 9: an embodiment of embodiments 1-8, wherein the washed zinc content is greater than 600 ppm.

Embodiment 10: an embodiment of embodiments 1-9, wherein the washed article comprises greater than 600 ppm zinc and has an RV greater than 2.

Embodiment 11: an embodiment of embodiments 1-10, wherein the antiviral/antimicrobial efficacy of the washed article increases after the maintaining step.

Embodiment 12: an embodiment of embodiments 1-11, wherein a wash cycle is an addition step followed by a maintenance step and wherein the process comprises multiple wash cycles.

Embodiment 13: an embodiment of embodiments 1-12, wherein the washed AM/AV metal content is at least 50% greater than the initial AM/AV metal content after 40 wash cycles.

Embodiment 14: an embodiment of embodiments 1-13, wherein the washed article demonstrates a Klebsiella pneumonia log reduction greater than 3, as determined via ISO20743:2013 and/or an Escherichia coli log reduction greater than 3, as determined via ASTM E3160 (2018).

Embodiment 15: an embodiment of embodiments 1-14, wherein the wash solution comprises municipal water and the municipal water comprises AM/AV metal.

Embodiment 16: an embodiment of embodiments 1-15, wherein the wash solution comprises water and an added AM/AV metal compound.

Embodiment 17: an embodiment of embodiments 1-16, wherein AM/AV metal retention is over 100% (growth).

Embodiment 18: an embodiment of embodiments 1-17, a detergent pod comprising soap and AM/AV metal compound.

Embodiment 19: a process for washing an article comprising a polymer to add AM/AV metal content, e.g. zinc content, the process comprising adding an article comprising a polymer and an initial AM/AV metal content, e.g., an initial zinc content, to a wash solution comprising water and the detergent pod; an maintaining the article in the wash solution for a wash time greater than 10 seconds to yield a washed article comprising a washed AM/AV metal content; wherein the washed AM/AV metal content is greater than the initial AM/AV metal content; and wherein the washed article optionally demonstrates a Klebsiella pneumonia log reduction greater than 0.90, as determined via ISO20743:2013 and/or an Escherichia coli log reduction greater than 1.5, as determined via ASTM E3160 (2018).

Embodiment 20: an embodiment of embodiment 19, wherein the wash solution comprises water and a wash solution AM/AV metal content.

Embodiment 21: an embodiment of embodiment 19 or 20, wherein the washed AM/AV metal content is at least 10% greater than the initial AM/AV metal content.

Embodiment 22: an embodiment of embodiments 19-21, wherein the washed AM/AV metal content is greater than the wash solution AM/AV metal content.

While the invention has been described in detail, modifications within the spirit and scope of the invention will be readily apparent to those of skill in the art in view of the foregoing discussion, relevant knowledge in the art, and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

We claim:

1. A wet treatment process, the process comprising:
adding an article comprising a polymer and an initial AM/AV metal content to a wash solution comprising solute and a wash solution zinc content;
maintaining the article in the wash solution for a wash time greater than 10 seconds to yield a washed article comprising a washed AM/AV metal content;
wherein the washed AM/AV metal content is greater than the initial AM/AV metal content.

2. The process of claim 1, wherein the washed article demonstrates a Klebsiella pneumonia log reduction greater than 0.90, as determined via ISO20743:2013 and/or an Escherichia coli log reduction greater than 1.5, as determined via ASTM E3160 (2018).

3. The process of claim 1, wherein the washed AM/AV metal content is at least 10% greater than the initial AM/AV metal content.

4. The process of claim 1, wherein the difference between the washed AM/AV metal content and the initial AM/AV metal content is greater than the wash solution AM/AV metal content.

5. The process of claim 1, wherein the washed AM/AV metal content is greater than the wash solution AM/AV metal content.

6. The process of claim 1, wherein the washed article demonstrates a log reduction increase of at least 1.0 over the log reduction of the article.

7. The process of claim 1, wherein the polymer comprises PA6, PA66, PA10, PA12, PA6T, or PA6I, or copolymers or terpolymers thereof.

8. The process of claim 1, wherein the wash solution comprises from 200 ppm to 22000 ppm AM/AV metal.

9. The process of claim 1, wherein the wash solution has a pH greater than 3.5.

10. The process of claim 1, wherein the washed AM/AV metal content is greater than 600 ppm.

11. The process of claim 1, wherein the washed article comprises greater than 600 ppm zinc and has an RV greater than 2.

12. The process of claim 1, wherein a wash cycle is an addition step followed by a maintenance step and wherein the process comprises multiple wash cycles.

13. The process of claim 12, wherein the washed AM/AV metal content is at least 50% greater than the initial AM/AV metal content after 40 wash cycles.

14. The process of claim 1, wherein the washed article demonstrates a Klebsiella pneumonia log reduction greater than 3, as determined via ISO20743:2013 and/or an Escherichia coli log reduction greater than 3, as determined via ASTM E3160 (2018).

15. The process of claim 1, wherein the wash solution comprises municipal water and the municipal water comprises AM/AV metal.

16. A detergent pod comprising soap and AM/AV metal compound.

17. A process for washing an article comprising a polymer to add AM/AV metal content, the process comprising:
adding an article comprising a polymer and an initial AM/AV metal content to a wash solution comprising solute and the detergent pod of claim 16; and
maintaining the article in the wash solution for a wash time greater than 10 seconds to yield a washed article comprising a washed AM/AV metal content;
wherein the washed AM/AV metal content is greater than the initial AM/AV metal content.

18. The process of claim 17, wherein the washed article demonstrates a Klebsiella pneumonia log reduction greater than 0.90, as determined via ISO20743:2013 and/or an Escherichia coli log reduction greater than 1.5, as determined via ASTM E3160 (2018).

19. The process of claim 17, wherein the washed AM/AV metal content is at least 10% greater than the initial AM/AV metal content.

20. The process of claim 17, wherein the washed AM/AV metal content is greater than the wash solution AM/AV metal content.
